(19) United States
(12) Patent Application Publication
(10) Pub. No.: US 2016/0196944 A1
(43) Pub. Date: Jul. 7, 2016

(54) ELECTRICAL CONTACT APPARATUS, ASSEMBLIES, AND METHODS OF OPERATION

(71) Applicant: SIEMENS AKTIENGESELLSCHAFT, MÜNCHEN (DE)

(72) Inventors: Bogdan Ionescu, McMurray, PA (US); Peter Willard Hammond, Greensburg, PA (US); Richard H. Osman, Pittsburgh, PA (US)

(21) Appl. No.: 15/072,915

(22) Filed: Mar. 17, 2016

Related U.S. Application Data
(63) Continuation of application No. 13/928,477, filed on Jun. 27, 2013.
(60) Provisional application No. 61/665,988, filed on Jun. 29, 2012.

(51) Int. Cl. H01H 71/24; H01H 50/54; H01H 50/18

(52) U.S. Cl. CPC H01H 71/24; H01H 50/18; H01H 50/54

(57) ABSTRACT

An electrical contact apparatus is disclosed. The contact apparatus has first contact member having a first contact, a movable contact member received adjacent to the first contact member, the movable contact member having an opposing contact positioned adjacent the first contact, and an armature operable to produce an electromagnetic closing force to cause the movable contact member to remain closed upon application of current through the first contact member, movable contact member. Contact assemblies and methods of operating the contact apparatus are disclosed, as are other aspects.

### CROSS-REFERENCE TO RELATED APPLICATIONS

This application claims the benefit of U.S. patent application Ser. No. 13/928,477 filed on Jun. 27, 2013, which claims priority from U.S. Provisional Patent Application Ser. No. 61/665,988 filed on Jun. 29, 2012, the disclosures of which are hereby incorporated by reference in its entirety herein.

### TECHNICAL FIELD

The present invention relates generally to electrical contact assemblies, and more particularly to electrical contact apparatus within electrical contact assemblies.

### BACKGROUND

Mechanical devices for electrical switching may need to survive a fault or short-circuit condition, in which the electrical current through the electrical device may be many times larger than the device's continuous current rating (the so-called rated current). If such a fault current lasts even a few seconds, the conductive parts of the electrical device may be degraded or even melt, and the electrical device may be destroyed, or otherwise may not continue to function as intended. This may also possibly damage other components connected to the electrical device. One remedy is to design the electrical device to detect the fault current and to interrupt it, as for example in a circuit breaker. However, the ability to interrupt large fault currents comes at a substantial cost, and may dictate the use of refractory metals, arc-splitters, and magnetic arc deflection.

If a second electrical device is protected by a first device, which will interrupt the current (e.g., a fuse or a circuit breaker), then there may be no need to add the cost of interrupting capability to the second device. However, while the fault current is flowing, a repulsive force proportional to the square of the current will act to separate the electrical contacts of the second device. This repulsive or “blow-apart” force has been dealt with in prior electrical devices by providing a spring bias to the movable contacts thereby providing an opposing force of sufficient magnitude to hold the contacts in a closed condition, i.e., to prevent the electrical contact from blowing apart. If the contacts blow apart, even though only slightly, they may arc or weld, and the second device may be destroyed or compromised. Such electrical devices may have quite heavy contact biasing springs.

Thus, it should be recognized that during a short-circuit condition, due to very high electrical fault currents flowing axially through the electrical contacts (e.g., contact buttons) of the contactor apparatus, the blow-apart force is developed in the contact region that acts to separate the electrical contacts. As a result, the contact pressure normally produced by the biasing spring(s) and/or actuator of the contactor is decreased. The net result is increased power loss in the electrical contact region, which may lead to contact welding or to other undesirable effects.

Thus, electrical contact apparatus adapted to offset the aforementioned lowered contact force are desired.

### SUMMARY

In a first embodiment, an electrical contact apparatus is provided. The electrical contact apparatus includes a first contact member having a first end and a second end, and a first contact at the second end, a second contact member having a first end and a second end, and having a second contact at the second end, a movable contact member received adjacent to the second ends of the first contact member and the second contact member, the movable contact member having third contact positioned adjacent the first contact, and fourth contact positioned adjacent the second contact, the third and fourth contacts of the movable conductor member being configured and adapted to be moved into and out of engaging contact with the first contact and the second contact; and a first armature positioned adjacent to at least the first contact and third contact and operable to produce a force to cause the movable contact member to remain closed upon application of current through the first contact member, movable contact member, and second contact member. In a further embodiment, the first and second armatures may extend alongside of respective lateral sides of the first and second contact members such that the first and second armatures extend beyond the lateral sides of the first and second contact members to respective lateral sides of the moveable contact member upon application of current through the first contact member.

In yet another aspect, a contact assembly is provided. The contact assembly includes a contact apparatus having a first contact member having a first end and a second end, and a first contact at the second end, a second contact member having a first end and a second end, and having a second contact at the second end, a movable contact member received adjacent to the second ends of the first contact member and the second contact member, the movable contact member having third contact positioned adjacent the first contact, and fourth contact positioned adjacent the second contact, the third and fourth contacts of the movable conductor member being configured and adapted to be moved into and out of engaging contact with the first contact and the second contact, and a first armature positioned adjacent to at least the first contact and third contact and operable to produce a force to cause the movable contact member to remain closed upon application of current through the first contact member, movable contact member, and second contact member; and an actuator mechanism coupled to the movable contact member and adapted to open and close the contact apparatus.

In a method embodiment, a method of operating a contact apparatus is provided. The method includes providing a contact apparatus having a first contact member having a first contact, a second contact member having a second contact, a movable contact member received adjacent to the first contact member and the second contact member, the movable contact member having third contact positioned adjacent the first contact, and fourth contact positioned adjacent the second contact, and a first armature positioned adjacent to at least the first contact and third contact, and producing a closing force to cause the movable contact member to remain closed, the closing force produced upon application of current through the first contact member, movable contact member, and second contact member.

In yet another aspect, an electrical contact apparatus is provided. The electrical contact apparatus, comprising a first contact member having a first contact, a movable contact member having an opposing contact positioned adjacent to the first contact, the first contact and opposing contact being configured and operable to be moved into and out of engaging contact, and an armature positioned adjacent to the first contact and opposing contact and operable to produce an electromagnetic force opposed to a blow-apart force produced when a fault current is passed through the first contact member and movable contact member.

In another method embodiment, a method of operating a contact apparatus is provided. The method includes providing a contact apparatus having a first contact member with a first contact, a movable contact member with an opposing contact, the first contact and opposing contact being configured to be moved into and out of engaging contact, and an armature positioned adjacent to the first contact and opposing contact, and producing an electromagnetic force opposed to a blow-apart force produced when a fault current is passed through the first contact member and movable contact member.

Still other aspects, features, and advantages of the present invention may be readily apparent from the following detailed description by illustrating a number of example embodiments and implementations, including the best mode contemplated for carrying out the present invention. The present invention may also be capable of other and different embodiments, and its several details may be modified in various respects, all without departing from the scope of the present invention. Accordingly, the drawings and descriptions are to be regarded as illustrative in nature, and not as restrictive. The invention is to cover all modifications, equivalents, and alternatives falling within the scope of the invention.

### BRIEF DESCRIPTION OF THE DRAWINGS

FIG. 1A illustrates an isometric view of an electrical contact apparatus according to embodiments.

FIG. 1B illustrates a cross-sectioned end view of the electrical contact apparatus taken along section line 1B-1B of FIG. 1A according to embodiments.

FIGS. 1C and 1D illustrate isometric views of the first and second contact members according to embodiments.

FIG. 1E illustrates an isometric bottom view of a movable contact member according to embodiments.

FIG. 1F illustrates a cross-sectioned side view of the electrical contact apparatus taken along section line 1F-1F of FIG. 1A according to embodiments.

FIG. 1G illustrates an isometric view of an armature according to embodiments.

FIG. 2A illustrates an isometric view of another electrical contact apparatus according to embodiments.

FIG. 2B illustrates a cross-sectioned end view of an electrical contact apparatus taken along section line 2B-2B of FIG. 2A according to embodiments.

FIG. 2C illustrates an isometric view of a first contact member (as well as a second contact member) according to embodiments.

FIGS. 2D and 2E illustrate isometric top and bottom views, respectively, of a movable contact member according to embodiments.

FIG. 3A illustrates an isometric top view of a movable contact member assembly according to embodiments.

FIG. 3B illustrates an isometric bottom view of a movable contact member assembly according to embodiments.

FIG. 3C illustrates a cross-sectioned side view of a movable contact member assembly taken along section line 3C-3C of FIG. 3A according to embodiments.

FIG. 3D illustrates an isometric view of a centerpiece member according to embodiments.

FIG. 3E illustrates an isometric top view of an electrical contact apparatus including a movable contact member assembly according to embodiments.

FIG. 4 illustrates an isometric top view of another contact apparatus including a movable contact member with supplemental armatures according to embodiments.

FIG. 5 illustrates an isometric top view of another contact apparatus including U-shaped supplemental armatures according to embodiments.

FIG. 6 illustrates an isometric top view of another contact apparatus including dual supplemental armatures according to embodiments.

FIG. 7 illustrates an isometric top view of another contact apparatus including dual L-shaped supplemental armatures according to embodiments.

FIG. 8 illustrates an isometric top view of another contact apparatus including end-mounted supplemental armatures according to embodiments.

FIG. 9 illustrates a cross-sectioned side view of an electrical contact assembly according to embodiments.

FIG. 10 is a flowchart illustrating a method of operating a contact apparatus according to embodiments.

FIG. 11A illustrates an isometric top view of another electrical contact apparatus according to embodiments.

FIG. 11B illustrates a cross-sectioned side view of another electrical contact apparatus taken along section lines 11B-11B of FIG. 11A according to embodiments.

FIG. 12 is a flowchart illustrating a method of operating an electrical contact apparatus according to embodiments.

### DETAILED DESCRIPTION

In view of the foregoing difficulties, improved electrical contact apparatus and assemblies are provided. Embodiments of the invention provide improved contact structure that are configured and adapted to allow “shaping” of the distribution of a magnetic field in the region of the movable contact member (sometimes referred to as a contact bridge) by a suitable placement of one, and preferably two, magnetically-permeable armatures. The high-permeability armatures can be either solid, powdered metal, or packaged together as a stack of laminations. The high-permeability armatures may be steel or iron, for example. Other suitable high permeability materials may be used.

Embodiments of the electrical contact apparatus and assembly have been described herein are useful in contactor apparatus, electrical contact devices where it is important to keep electrical contacts closed during fault or otherwise high current conditions, motor starters, disconnect switches, and the like.

As will become apparent, the electrical contact apparatus may advantageously allow the engaging electrical contact or contacts of the movable contact member to be urged more forcefully into contact with the electrical contact or contacts of the stationary contact member (e.g., contact pads). Accordingly, instances of contact separation causing contact welding and/or degradation may be minimized or avoided.

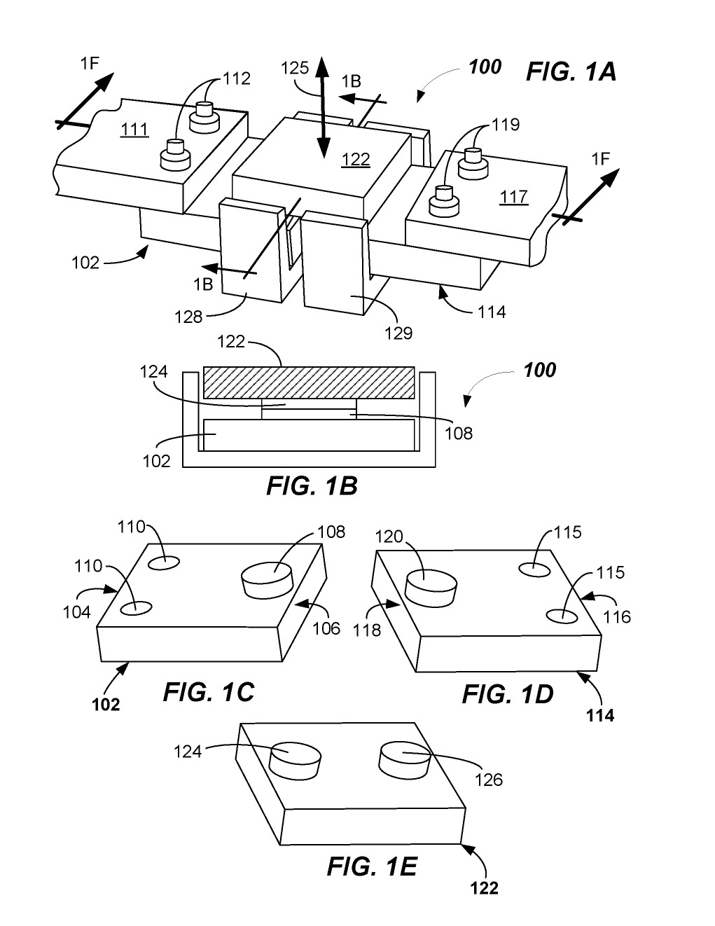

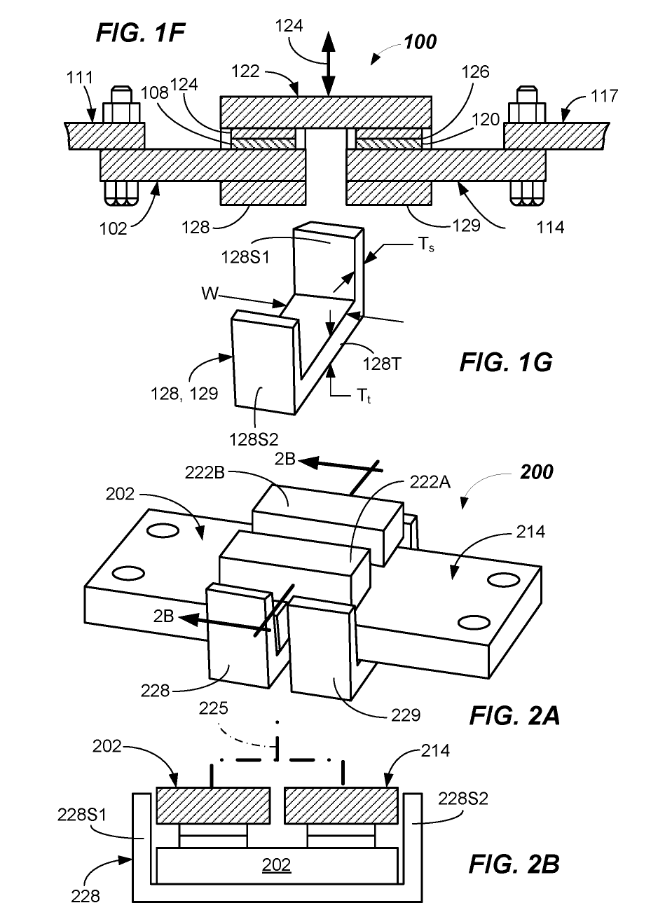

These and other embodiments of the electrical contact apparatus, contact assemblies, and methods of operating the contact assemblies and apparatus are described below with reference to FIGS. 1A-12.

Referring now in specific detail to FIGS. 1A-1G, an electrical contact apparatus 100 and components thereof is shown. The contact apparatus 100 may be used as a subcomponent of a larger electrical assembly (not shown), such as electrical contact assembly.

The electrical contact apparatus 100 may include a first contact member 102 having a first end 104 and a second end 106 opposed from the first end 104. The first contact member 102 may include a first contact 108, such as a conventional contact button, located and secured at the second end 106. First contact 108 may be a contact made of a silver-coated copper or silver-coated, copper-alloy material, for example. Other suitable contact materials may be used. First contact member 102 may include one or more features 110 (FIG. 1C) adapted and configured to attach the first contact member 102 to another conductor, such as an electrical bus 111. One or more features 110 may be one or more holes that may receive fasteners 112, such as screws or bolts therein. First contact member 102 may comprise a silver-coated copper plate, for example. Other constructions and material may be used. Moreover, any suitable electrical connection may be provided.

Electrical contact apparatus 100 may include a second contact member 114, also having a first end 116 and a second end 118, and which may have a third contact 120 secured at the second end 118. The second contact member 114 and third contact 120 may be identical to the first contact member 102 and first contact 108. The second contact member 114 may include one or more features 115 (FIG. 1D) adapted and configured to attach the second contact member 114 to another conductor, such as a second electrical bus 117. One or more features 115 may be one or more holes that may receive fasteners 119, such as screws or bolts therein. Second contact member 114, like first contact member 102, may comprise a silver-coated copper plate, for example. Other constructions and material may be used.

Electrical contact apparatus 100 includes, as shown in FIGS. 1A, 1B, 1E, and 1F, a generally planar movable contact member 122 that is received adjacent to the second ends 106, 118 of the respective first and second contact members 102, 114 in the depicted embodiment. Movable contact member 122 having third contact 124 positioned adjacent the first contact 108 and opposed thereto, and fourth contact 126 positioned adjacent the second contact 120 and opposed thereto. Third and fourth contacts 124, 126 of the movable conductor member 122 are configured and adapted to be moved into and out of contact with the first and second contacts 108, 120. Movement may be accomplished by a suitable actuator coupled to the contact apparatus 100. The line of action of the force vector on the movable contact member 122 is shown by arrow 125.

A first armature 128 is positioned adjacent to at least the first contact 108 and third contact 124 and is operable to assist in producing an electromagnetic force to cause the movable contact member 122 to remain closed upon application of current through the first contact member 102, movable contact member 122, and second contact member 114. The force causes the first contact 108 and third contact 124 to be urged into engaged contact more forcefully.

A second armature 129 may be provided and may operate to urge the second contact 120 and fourth contact 126 into engaged contact more forcefully upon application of an electrical current through the first contact member 102, movable contact member 122, and second contact member 114.

First and second armatures 128, 129 may comprise a magnetically-permeable material, such as SAE 1008 or SAE 1010 steel. Other magnetically-permeable materials may be used. Optionally, the first and second armatures 128, 129 may comprise a powdered metal material. The powdered metal material may be a powdered iron, such as F-0000-10, -15, or -20 powdered iron per MPIF Standard 35. The density of the powdered metal material may be between about 6.0 g/cm³ and about 7.5 g/cm³, for example. Other densities and types of powdered metal materials including powdered metal alloys may be used. In other embodiments, the first and second armatures 128, 129 may be formed from a solid formed channel of magnetically-permeable material, and may be have rounded corners. The first and/or second armatures 128, 129 may be laminated steel in some embodiments.

First armature 128 may comprise a transverse portion 128T and two side portions 128S1, 128S2 extending from ends of the transverse portion 128T, thus forming a U-shaped armature. The side portions 128S1 and 128S2 may extend substantially perpendicularly from the transverse portion 128T, in some embodiments wherein the two side portions 128S1, 128S2 extend alongside of lateral sides of the first contact member 102 and second contact member 114. The transverse portion 128T extends along the underside of the first contact member 102, as shown. Second armature 129 may be substantially identical to first armature 128. The first and second armatures 128, 129 may be securely fastened to the undersides of the first contact member 102 and the second contact member 114, such as by suitable fasteners (e.g., screws) or the like. Any suitable fastening means may be used. It should be appreciated, in an exemplary embodiment, that the first and second armatures 128, 129 may be operatively secured to the underside of different contact members, that is, the first armature 128 may be secured to a different contact member than the second armature 129.

In operation, the current flowing through the first contact member 102, movable contact member 122, and second contact member 114 functions to induce and create a significant magnetic field that produces a significant electromagnetic force acting to urge the contacts 124, 126 of the movable contact member 122 into more intimate contact with the contacts 108, 120 of the first and second contact members 102, 114. This electromagnetic force tends to keep the contacts closed, and, thus, assists any force that may be provided by contact springs (not shown). Thus during short circuit or fault conditions, the contact pairs 108, 124, and 120, 126 have a reduced tendency to separate and the contact force may be maintained at an appropriate level. This created electromagnetic force offsets the blow-apart force produced tending to open the contact pairs 108, 124 and 120, 126 due to current flow axially through the first and third contacts 108, 124 and the second and fourth contacts 120, 126.

In the depicted embodiment, the first and second armatures 128, 129 may have, as shown in FIG. 1G, a thickness (Tₜ) of the transverse portion 128T that is between about 1 mm and about 10 mm, for a 1250 A rated current contact apparatus and a fault current of about 20,000 A. The thickness (Tₛ) of the side portions 128S1, 128S2 may be between about 1 mm and 10 mm, for example. The width W of the armatures 128, 129 may be approximately between 10 mm and 50 mm, for example. Other dimensions may be used, and Tₜ and Tₛ may be the same or different. As will be apparent, the side portions 128S1, 128S2 may be received proximate to the respective opposite sides of the movable contact member 122. Different current ratings and short-circuit current levels above or below the mentioned values are possible for other electrical devices in which embodiments of the invention may be used. It yet a further embodiment, the side portions 128S1, 128S2 extending alongside the lateral sides of the contact members, may further extend beyond the lateral sides of the contact members and alongside respective lateral sides of the moveable contact member 122.

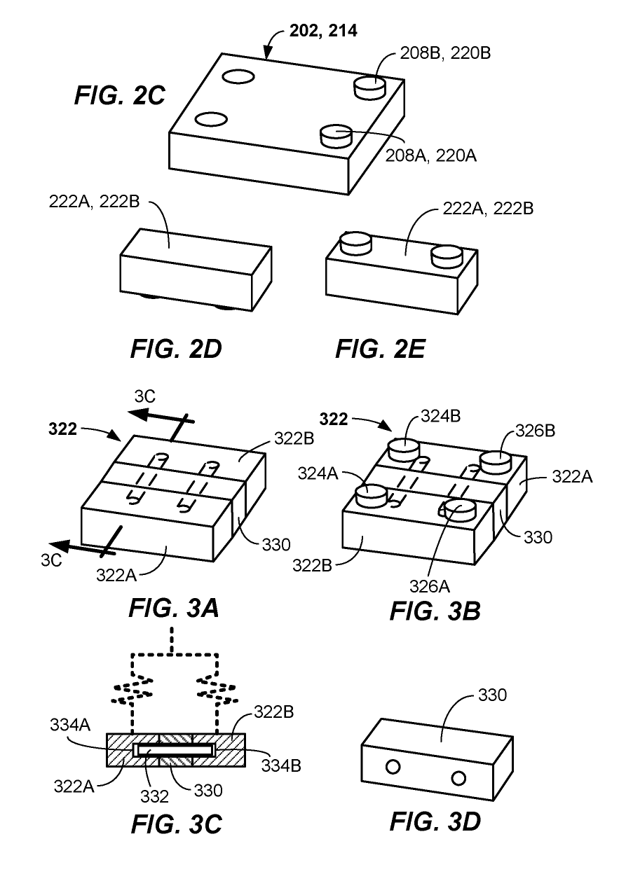

FIGS. 2A-2E illustrates another embodiment of the contact apparatus 200 and components thereof. This embodiment differs from the first embodiment in that it includes first and second contact members 202, 214 having dual contacts 208A, 208B and 220A, 220B thereon, such as shown in FIG. 2C. Additionally, the generally planar movable contact member 122 may be comprised of a first and second portion, e.g., a first and a second movable contact member 222A, 222B (FIG. 2A). In this exemplary embodiment, the first and second movable contact members 222A, 222B may be provided in a side-by-side relationship and are actuated in unison by an attached actuator mechanism (not shown, but designated by dotted lines 225). Any suitable actuation mechanism may be used.

In the depicted embodiment, the first and second armatures 228, 229 are configured as described for the single contact embodiment. In particular, the two side portions 228S1 and 228S2 extend alongside of lateral sides of the first contact member 202 as shown in FIG. 2B. Likewise, the two side portions 228S1, 228S2 may extend alongside of lateral sides of the second contact member 214 as shown in FIG. 2A. In yet a further exemplary embodiment, the two side portions 228S1, 228S2 may extend beyond the lateral sides of one or both of the first and second contact members and alongside respective lateral sides of the moveable contact member(s) 222a, 222B.

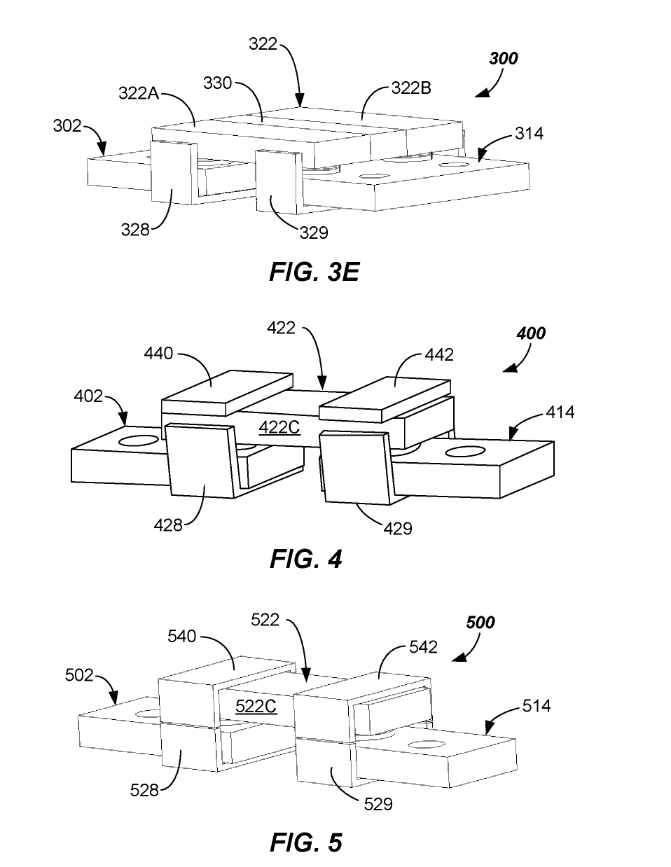

FIGS. 3A-3E depicts an alternate embodiment of an electrical contact apparatus 300 having a movable contact member 322 and components thereof. In the depicted embodiment, a magnetically-permeable centerpiece member 330 is included and positioned between the first and second movable contact members 322A, 322B. A retaining member 332 (FIG. 3C) may be provided to maintain an approximate spatial relationship between the first and second movable contact members 322A, 322B, yet allow a small amount of relative vertical motion there between. The retaining member 332 may be a steel pin (e.g., a roll pin) driven through an aperture in the magnetically-permeable centerpiece member 330 and whose ends are inserted loosely into pockets 334A, 334B formed in each of the first and second movable contact members 322A, 322B, and extending through the magnetically-permeable centerpiece member 330, for example. Pockets 334A, 334B may be larger in diameter than the retaining member 332. Other features adapted to allow a limited amount of motion between the first and second movable contact members 322A, 322B may be used to ensure intimate engagement of the contacts. Likewise, other means for retaining the magnetically-permeable centerpiece member 330 in position between the movable contact members 322A, 322B may be used. The limited motion allows the first and second movable contact members 322A, 322B to seek a position in contact with their respective contacts when, for example, the contacts may be of different heights or have different degrees of wear. Opening and closing of the movable contact members 322A, 322B may be provided by a suitable actuator, which may be coupled to the movable contact members 322A, 322B through bias springs. Further enhancement of the contact force is obtainable by placing the magnetically-permeable centerpiece member 330 made of, for example, a magnetically-permeable steel between the movable contact members 322A, 322B (otherwise referred to as mobile contact bridges). As previously described with reference to FIGS. 1A-1B, each of the movable contact members 322A, 322B may include conventional contacts 324A, 324B and 326A, 326B (e.g., contact buttons). Armatures 328, 329 partially surrounding first and second contact members 302, 314 and acting on magnetically-permeable centerpiece member 330 provide enhanced contact forces by way of magnetic fields produced in the armatures when current flows through the first and second contact members 302, 314 and movable contact member 322.

FIG. 4 depicts an alternate embodiment of a contact apparatus 400 and components thereof. In this embodiment, the contact apparatus 400 includes a first contact member 402, second contact member 414, and first and second armatures 428, 429, all as previously described. In addition, the movable contact member 422 of the contact apparatus 400 may be generally planar and include at least one, and preferably two, supplemental armatures 440, 442 that may be securely coupled to and move with the conductive portion 422C of the movable contact member 422. The supplemental armatures 440, 442 may be attached to the upper surfaces of the ends of the conductive portion 422C as shown, such as by suitable fasteners (e.g., screws or the like). The supplemental armatures 440, 442 may be made of a magnetically-permeable metal, such as steel as described herein. The supplemental armatures 440, 442 may have a flat bar shape, and may be coupled to the surface of the conductive portion 422C opposite the contacts, as shown. Furthermore, the supplemental armatures 440, 442 may be aligned with and preferably overlay the sides of the respective armatures 428, 429. The supplemental armatures 440, 442 may extend beyond the lateral sides of the conductive portion 422C.

FIG. 5 depicts another alternate embodiment of a contact apparatus 500 and components thereof. In this embodiment, the contact apparatus 500 includes a first contact member 502, second contact member 514, and first and second armatures 528, 529, all as previously described. In addition, the movable contact member 522 of the contact apparatus 500 may include at least one, and preferably two, supplemental armatures 540, 542 that may be securely coupled to and move with the conductive portion 522C of the movable contact member 522. The supplemental armatures 540, 542 may be attached to the ends of the conductive portion 522C, such as by suitable fasteners (e.g., screws or the like). The supplemental armatures 540, 542 may be made of a magnetically-permeable metal, such as steel as described herein, and may be U-shaped members. The supplemental armatures 540, 542 may be substantially identical to the first and second armatures 528, 529 in some embodiments. The supplemental armatures 540, 542 may be coupled to the surface of the conductive portion 522C opposite the contacts, as shown. Furthermore, the respective sides of the supplemental armatures 540, 542 may be aligned with and preferably overlay the respective sides of the armatures 528, 529. A side air gap between the ends of the sides of the respective first armature 528 and the first supplemental armature 540 and between the ends of the second armature 529 and the second supplemental armature 542 should be greater than about 1 mm and less than about 10 mm, for example. Other air gap dimensions may be used. Similar air gaps may be provided in the FIG. 4 embodiment. It should be appreciated that the sides of the respective armatures, e.g., armatures 428, 429 in FIG. 4, may extend in a direction beyond the lateral side surface of, e.g., the first 402 and second 414 contract members, and towards, e.g., the supplemental armatures 440, 442, resulting in a closed air gap or an air gap, e.g., of at least or about 1 mm.

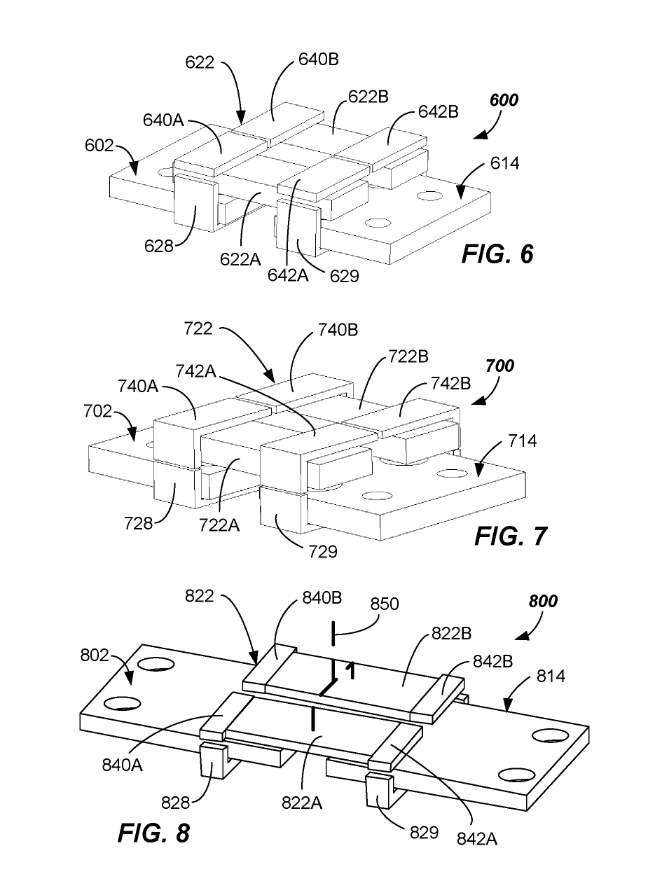

FIG. 6 depicts an alternate embodiment of a contact apparatus 600 and components thereof. In this embodiment, the contact apparatus 600 includes a first contact member 602, second contact member 614, and first and second armatures 628, 629 extending underneath and alongside of the lateral sides of the first contact member 602 and second contact member 614, all as previously described. In addition, the movable contact member 622 of the contact apparatus 600 may include supplemental armatures 640A, 640B, and 642A, 642B that may be securely coupled to, and move with, the conductive portions 622A, 622B of the movable contact member 622, which may be arranged in a side-by-side orientation, as shown. The supplemental armatures 640A, 640B, and 642A, 642B may be attached to the ends of the conductive portions 622A, 622B, such as by suitable fasteners (e.g., screws or the like).

The supplemental armatures 640A, 640B, 642A, 642B may be made of a magnetically-permeable metal, such as steel as described herein. The supplemental armatures 640A, 640B, 642A, 642B may have a flat bar shape, and may be coupled to the surface of the conductive portions 622A, 622B opposite the contacts, as shown. Furthermore, the supplemental armatures 640A, 640B, 642A, 642B may be aligned with and preferably overlay the respective sides of the armatures 628, 629. The supplemental armatures 640A, 640B and 642A, 642B may extend alongside of the lateral sides of the conductive portions 622A, 622B in some embodiments. An air gap between the ends of the armatures 628, 629 and the respective ends of the supplemental armatures 640A, 640B, 642A, 642B may be greater than about 1 mm and less than about 10 mm. Other gaps may be used. The center gaps between the respective ends of the supplemental armatures 640A, 640B and between the ends of supplemental armatures 642A, 642B allow for limited independent motion of the conductive portions 622A, 622B. The center air gaps respective ends of the supplemental armatures 640A, 640B, 642A, 642B may be greater than about 0 mm and less than about 10 mm. Other center air gaps may be provided

FIG. 7 depicts yet another alternate embodiment of a contact apparatus 700 and components thereof. In this embodiment, the contact apparatus 700 includes a first contact member 702, second contact member 714, and first and second armatures 728, 729 extending underneath and alongside of the lateral sides of the first contact member 702 and second contact member 714, all as previously described. In addition, the movable contact member 722 of the contact apparatus 700 may include L-shaped supplemental armatures 740A, 740B, and 742A, 742B that may be securely coupled to, and move with, the conductive portions 722A, 722B of the movable contact member 722, which are arranged in a side-by-side orientation. The supplemental armatures 740A, 740B, and 742A, 742B may be attached to the ends of the conductive portions 722A, 722B, such as by suitable fasteners (e.g., screws or the like). Supplemental armatures 740A, 740B, and 742A, 742B and armatures 728, 729 may be made of magnetically-permeable steel, such as SAE 1008 or SAE 1010 steel or other suitable magnetically-permeable material.

The side air gap between the ends of the respective sides of the respective U-shaped first armature 728 and the L-shaped first supplemental armature 740A (and between the U-shaped first armature 728 and the L-shaped second supplemental armature 740B) should be less than about 10 mm, for example. The side air gap may be greater than 1 mm in some embodiments. Other side air gaps dimensions may be used. Likewise, the air gap between the ends of the sides of the respective U-shaped second armature 729 and the L-shaped first supplemental armature 742A and between the U-shaped second armature 729 and the L-shaped second supplemental armature 742B may be greater than 1 mm and may be less than about 10 mm, for example. Other gap dimensions may be used. In some embodiments, the thickness of the transverse portion of the L-shaped armatures 740A, 740B, 742A, 742B may be thicker than the side portions to enlarge the center air gap area in order to minimize loss in field strength through the center air gap. The center air gap between the center ends of the L-shaped armatures 740A, 740B and 742A, 742B may be between about 0 mm and 10 mm, for example.

FIG. 8 depicts another alternate embodiment of a contact apparatus 800 and components thereof. In this embodiment, the contact apparatus 800 includes a first contact member 802, second contact member 814, and first and second armatures 828, 829 extending underneath and alongside of the lateral sides of the first contact member 802 and second contact member 814, all as previously described. In addition, the movable contact member 822 of the contact apparatus 800 may include bar-shaped supplemental armatures 840A, 840B, and 842A, 842B that may be solidly coupled and attached at the longitudinal ends of the conductive portions 822A, 822B, as shown. Bar-shaped supplemental armatures 840A, 840B, and 842A, 842B are adapted to move with the conductive portions 822A, 822B, which are arranged in a side-by-side orientation. The supplemental armatures 840A, 840B, and 842A, 842B may be attached to the longitudinal ends of the conductive portions 822A, 822B, such as by suitable fasteners (e.g., screws or the like). Supplemental armatures 840A, 840B, and 842A, 842B and armatures 828, 829 may be made of, for example, a magnetically-permeable steel, such as SAE 1008 or SAE 1010 steel or other suitable magnetically-permeable material.

A side air gap between the ends of the sides of the respective first armature 828 and the first supplemental armature 840A (and between the first armature 828 and the second supplemental armature 840B) may be greater than about 1 mm and less than about 10 mm, for example. Other side air gap dimensions may be used. The same air gaps may be provided between the ends of the sides of the respective second armature 729 and the first supplemental armature 842A and the second supplemental armature 842B. Other gap dimensions may be used. The center air gap measured in the transverse direction between the ends of the first and second supplemental armatures 840A, 840B at the center should be as small as possible without mechanical interference, and may be between about 0 mm and 10 mm in some embodiments. Conductive members 822A, 822B containing contacts may be actuated by a spring-loaded actuator mechanism 850 (shown as a dotted line).

Each of the above-described embodiments has the same purpose of supplementing the available contact force during a short circuit or fault condition. Thus, these additional armatures providing a spatial distribution of magnetically-permeable steel in the region of the moving contacts provide additional contact force assisting the force already provided by contact springs (not shown).

In one or more embodiments, such as those shown in FIGS. 1A and 2A, the physical effect derives from the expression of Lorentz force density which equals the cross product of the current density and magnetic flux density vectors, respectively. The current density in the movable contact member is a given quantity when the contacts are in the closed position, and when a short-circuit current flows, the magnetic field distribution in the moving contact member can be influenced by the convenient placement of permeable steel armatures in the contact region such that the enhancement of the contact force (pressure) is obtained at relatively high current levels. The alternative solution presented in the embodiments of FIGS. 3E, and 4-9 uses the attraction force between permeable steel armatures. Thus, improved operation of the contacts during short-circuit and fault conditions is possible. Furthermore, contact springs that are used in traditional configurations to provide contact force may be reduced in size in some embodiments. As a result of these embodiments of the invention, the operation of the contact apparatus becomes more reliable during such short-circuit and fault conditions. Optionally or additionally, the actuating mechanism (e.g. a solenoid) may be reduced in size and cost in some embodiments.

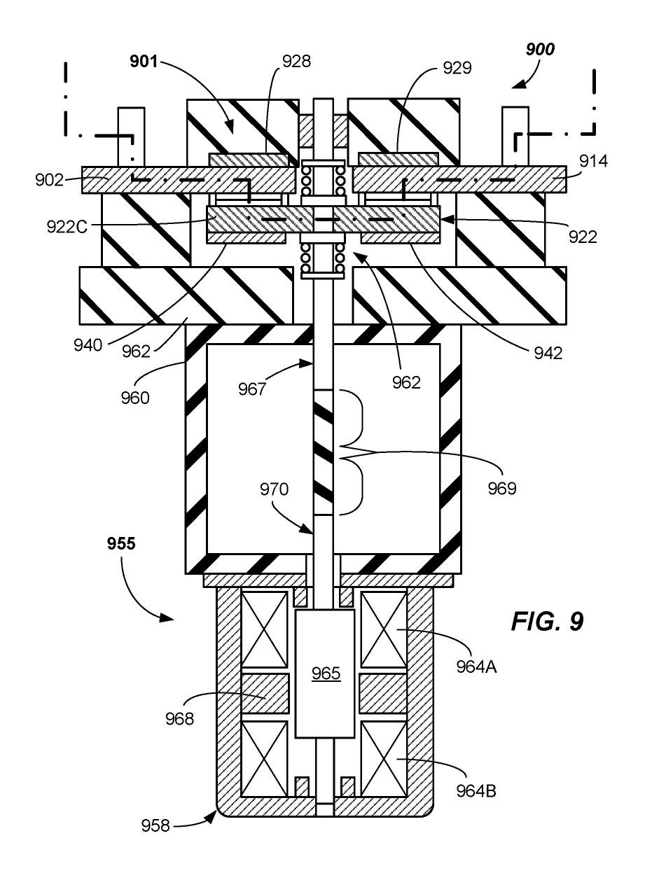

FIG. 9 depicts an embodiment of an electrical contact assembly 900 and components thereof. The contact assembly 900 includes a contact apparatus 901 and an actuator mechanism 955. The contact apparatus 901 may have the configuration of any of the contact apparatus 100, 200, 300, 400, 500, 600, 700, or 800 or otherwise described herein. In particular, the contact apparatus 901 includes a first contact member 902 and second contact member 914 that are mounted stationary in the assembly 900, and first and second armatures 928, 929 extending underneath and alongside of the lateral sides of the first contact member 902 and second contact member 914, and which may have a U-shape as previously described. The armatures 928, 929 may be positioned adjacent to the contacts.

In addition, the movable contact member 922 may include supplemental armatures 940 and 942 that may be solidly coupled and attached at the longitudinal ends of the movable conductive member 922C adjacent to the armatures 928, 929, as shown. The supplemental armatures 940, 942 may have any of the shapes described herein and are adapted to move with the conductive portions 922C.

The actuator mechanism 955 may be any suitable mechanism configured and operational to move the movable contact member 922 between an open (contact disengaged) and closed (contacts engaged) condition. In the depicted embodiment, the actuator mechanism 955 comprises an actuator 958 coupled to a frame member 960. Frame member 960 may be coupled to the actuator 958 and also to an insulating support 962 for supporting the stationary first and second contact members 902, 914. Fame member may be made of an insulating plastic material, such as a fiber-reinforced plastic, for example. Other suitable insulating materials may be used. Actuator 958 may include coils 964A, 964B, a central pole 965, and a surrounding magnet 968, such as a NdFeB magnet having a ring or other suitable shape. Other suitable magnets may be used. The actuator mechanism 955 may include a shaft 967 coupled to a central shaft 970 of the actuator 958. Shaft 967 may include an insulating portion 969 and a spring support 962. Spring support 962 includes one or more springs allowing the movable contact member 922 to be urged into contact with the contacts of the first and second contact members 902, 914 with a suitable biasing spring force. The actuator mechanism 955 is coupled to the movable contact member 922 and is adapted to open and close the contact apparatus 901.

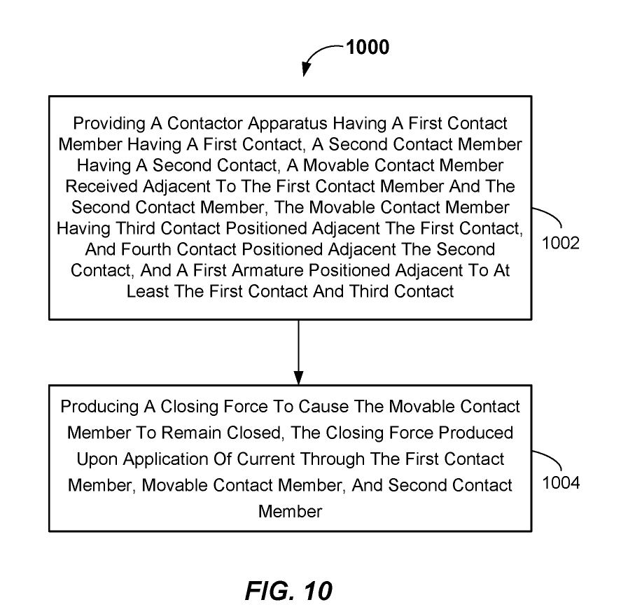

FIG. 10 is a flowchart that illustrates a method of operating a contact apparatus (e.g., 100, 200, 300, 400, 500, 600, 700, 800, and 901) according to embodiments. The method 1000 includes, in 1002, providing a contact apparatus having a first contact member (e.g., 102, 202, 302, 402, 502, 602, 702, 802, and 902) having a first contact (e.g., an electrical contact button), a second contact member (e.g., 114, 214, 314, 414, 514, 614, 714, 814, and 914) having a second contact (e.g., an electrical contact button), a movable contact member (e.g., 122, 222, 322, 422, 522, 622, 722, 822, and 922), received adjacent to the first contact member and the second contact member, the movable contact member having third contact (e.g., an electrical contact button) positioned adjacent the first contact, and fourth contact (e.g., an electrical contact button) positioned adjacent the second contact, and a first armature (e.g., 128, 228, 328, 428, 528, 628, 728, 828, and 928), positioned adjacent to at least the first contact and third contact.

The method 1000 includes, in 1004, providing producing a closing force, which may be an electromagnetic force, to cause the movable contact member to remain closed, the closing force being produced upon application of an electrical current through the first contact member, movable contact member, and second contact member. A second armature may be provided to balance the closing forces on the first and second contacts. The closing forces may be further augmented by adding supplemental armatures that move as part of the movable contact member wherein magnetic fields produced in the armatures attract the supplemental armatures.

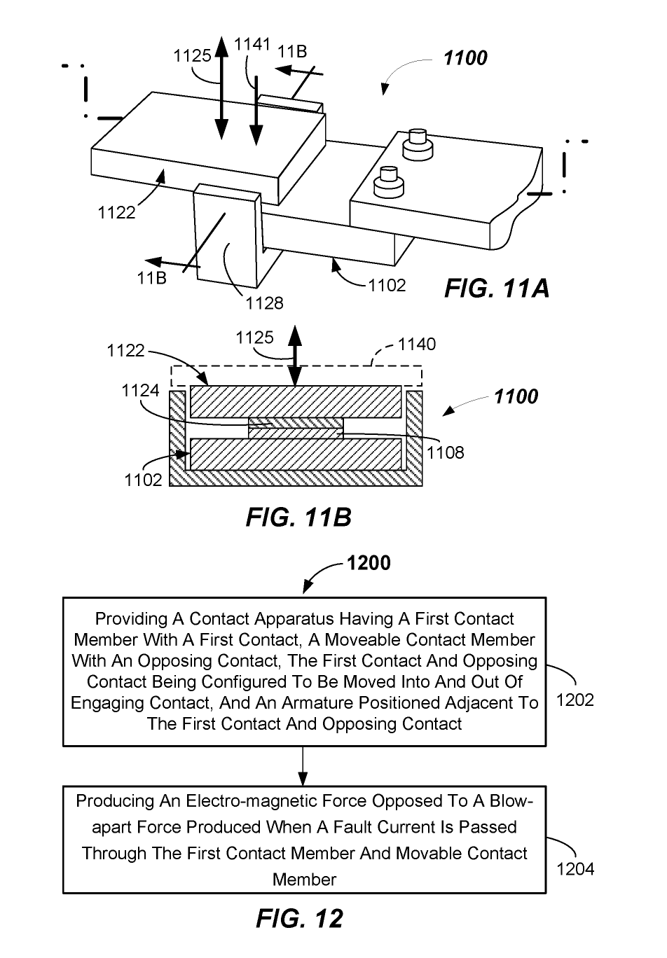

FIGS. 11A-11B depicts another alternate embodiment of an electrical contact apparatus 1100 and components thereof. In this embodiment, the electrical contact apparatus 1100 includes a first contact member 1102 having a first contact 1108 (e.g., a first contact button) secured thereto, and a movable contact member 1122 having an opposing contact 1124 (e.g., another contact button) secured thereto and positioned adjacent to the first contact 1108. The first contact 1108 and opposing contact 1124 are configured and operable to be moved into and out of engaging contact, such as by an actuator (not shown), but whose line of action is along force vector 1125. Electrical contact apparatus 1100 includes an armature 1128 positioned adjacent to the first contact 1102 and opposing contact 1122 and operable to produce an electromagnetic force 1141 opposed to a blow-apart force produced when a fault current is passed through the first contact 1102 member and movable contact member 1122 through the contacts 1108, 1124. Armature 1128 may be the same as heretofore described and may be positioned at any suitable location adjacent to the first contact member 1102 and movable contact member 1122.

In addition, the contact apparatus 1100 may include bar-shaped supplemental armature 1140 that may be solidly coupled and attached as part of the movable contact member 1122, as shown. The supplemental armature 1140 may be attached to the surface such as by suitable fasteners (e.g., screws or the like). Supplemental armature 1140 and armature 1128 may be made of, for example, a magnetically-permeable steel, such as AISI 1008 or 1010 steel or SAE 1008 or 1010 steel, or any other suitable magnetically-permeable material known in the art. Magnetic attraction forces may be produced between the armature 1128 and supplemental armature 1140 to supplement the contact closing forces present due to spring bias and/or actuator forces.

FIG. 12 is a flowchart that illustrates a method of operating a contact apparatus (e.g., 100, 200, 300, 400, 500, 600, 700, 800, 901, and 1100) according to embodiments. The method 1200 includes, in 1202, providing a contact apparatus having a first contact member (e.g., 102, 202, 302, 402, 502, 602, 702, 802, 902, 1102) with a first contact (e.g., an electrical contact button), a generally planar movable contact member (e.g., 122, 222, 322, 422, 522, 622, 722, 822, 922, and 1122) with an opposing contact (e.g., another electrical contact button), the first contact and opposing contact being configured to be moved into and out of engaging contact (e.g., such as by an actuator), and an armature (e.g., 128, 228, 328, 428, 528, 628, 728, 828, 928, and 1128) positioned adjacent to the first contact and opposing contact.

The method 1200 includes, in 1204, producing an electromagnetic force opposed to a blow-apart force produced when an electrical fault current is passed through the first contact member 1102 and movable contact member 1122. The blow-apart force is produced, in particular, when the current passes axially through the first contact 1108 and opposing contact 1124. Electromagnetic force produced in opposition of the blow-apart force may be a Lorenz force when no supplementary armature is provided. Electromagnetic force produced in opposition of the blow-apart force may be a magnetic attraction force acting on the supplementary armature when a supplementary armature (e.g., 330, 440, 540, 640A, 640B, 740A, 740B, 840A, 840B, 940, 1140) is provided on the movable contact member (e.g., 122, 222, 322, 422, 522, 622, 722, 822, 922, and 1122). In any event, the electromagnetic force is opposed to a blow-apart force and operates to reduce or eliminate the propensity of the electrical contacts to separate.

While specific embodiments have been described in detail, those with ordinary skill in the art will appreciate that various modifications and alternative to those details could be developed in light of the overall teachings of the disclosure. For example, elements described in association with different embodiments may be combined. Accordingly, the particular arrangements disclosed are meant to be illustrative only and should not be construed as limiting the scope of the claims or disclosure, which are to be given the full breadth of the appended claims, and any and all equivalents thereof. It should be noted that the terms “comprising”, “including”, and “having”, are open-ended and does not exclude other elements or steps and the use of articles “a” or “an” does not exclude a plurality. Additionally, the steps of various methods disclosed herein are not required to be performed in the particular order recited, unless otherwise expressly stated.

We claim:

1. An electrical contact apparatus, comprising:
a first contact member having a first end and a second end, and a first contact at the second end;
a second contact member having a first end and a second end, and having a second contact at the second end;
a generally planar movable contact member received adjacent to the second ends of the first contact member and the second contact member, the movable contact member having a third contact positioned adjacent the first contact, and a fourth contact positioned adjacent the second contact, the third and fourth contacts adapted to be moved into and out of engaging contact with the first and second contacts;
a first armature positioned adjacent to at least the first and third contacts and operatively secured to an underside of one of the first and second contact members; and
a second armature positioned adjacent to the second and fourth contacts and operatively secured to an underside of one of the first and second contact members, the first and second armatures operable to produce a force to cause the movable contact member to remain closed upon application of current through the first contact member, the movable contact member, and the second contact member.

2. The electrical contact apparatus of claim 1, wherein the first and second armatures extend alongside of respective lateral sides of the first and second contact members such that the first and second armatures extend beyond the lateral sides of the first and second contact members to respective lateral sides of the moveable contact member upon application of current through the first contact member.

3. The electrical contact apparatus of claim 2, wherein each of the first and second armatures comprises a transverse portion and two side portions extending from ends of the transverse portion, and wherein the two side portions of the first and second armatures extend beyond the lateral sides of the first and second contact members to respective lateral sides of the moveable contact member.

4. The electrical contact apparatus of claim 1, wherein the first and second armatures are operatively secured to different contact members.

5. The electrical contact apparatus of claim 1, wherein the first contact member is attached to a first electrical bus and the second contact member is attached to a second electrical bus.

6. The electrical contact apparatus of claim 1, wherein the movable contact member is comprised of a first and second portion in a side-by-side orientation.

7. The electrical contact apparatus of claim 6, comprising a magnetically-permeable centerpiece member positioned between the first and second portions of the movable contact member.

8. The electrical contact apparatus of claim 7, comprising a retaining member configured and adapted to maintain an approximate spatial relationship between the first and second portions of the movable contact member, yet allow an amount of relative motion between the first and second portions.

9. The electrical contact apparatus of claim 1, wherein the movable contact member comprises a supplemental armature on an opposite side from the third and fourth contacts.

10. The electrical contact apparatus of claim 6, comprising a supplemental armature coupled to each of the first and second portions of the movable contact member on an opposite side from the third and fourth contacts.

11. An electrical contact assembly, comprising:
a contact apparatus having
a first contact member having a first end and a second end, and a first contact at the second end,
a second contact member having a first end and a second end, and having a second contact at the second end,
a movable contact member having a generally planar profile and received adjacent to the second ends of the first contact member and the second contact member, the movable contact member having a third contact positioned adjacent the first contact, and a fourth contact positioned adjacent the second contact, the third and fourth contacts adapted to be moved into and out of engaging contact with the first contact and the second contact, and
a first armature positioned adjacent to at least the first contact and third contact and operable to produce a force to cause the movable contact member to remain closed upon application of current through the first contact member, movable contact member, and second contact member; and
an actuator mechanism coupled to a side of the movable contact member opposite the third and fourth contacts and adapted to open and close the contact apparatus.

12. The electrical contact assembly of claim 11, comprising a spring support coupled to the movable contact member.

13. The electrical contact assembly of claim 11, wherein the first armature extends alongside lateral sides of the first and second contact members such that the first armature extends beyond the lateral sides of the first and second contact members to respective lateral sides of the moveable contact member upon application of current through the first contact member.

14. The electrical contact assembly of claim 13, wherein the first armature comprises a transverse portion and two side portions extending from ends of the transverse portion.

15. The electrical contact assembly of claim 14, wherein the two side portions extend beyond the lateral sides of the first and second contact members to respective lateral sides of the moveable contact member.

16. The electrical contact assembly of claim 11, comprising a second armature positioned adjacent to the second contact and fourth contact.

17. A method of operating a contact apparatus according to claim 1, comprising the step of:
applying a current through the first contact member, the movable contact member, and the second contact member resulting in a closing force causing the movable contact member to remain closed.

18. The method of claim 16 wherein the closing force is generated by a magnetic attraction between the first and second armatures and a supplemental armature included on the movable contact member.

19. An electrical contact apparatus, comprising:
a first contact member having a first contact;
a generally planar movable contact member having an opposing contact positioned adjacent to the first contact, the first contact and opposing contact being configured and operable to be moved into and out of engaging contact; and
an armature positioned adjacent to the first contact and opposing contact and operable to produce an electromagnetic force opposed to a blow-apart force produced when a fault current is passed through the first contact member and movable contact member.

20. A method of operating a contact apparatus of claim 19, comprising the step of:
producing an electromagnetic force opposed to a blow-apart force produced when a fault current is passed through the first contact member and movable contact member.
